(19) United States
(12) Patent Application Publication
(10) Pub. No.: US 2020/0159443 A1
(43) Pub. Date: May 21, 2020

(54) Storage System and Method for Optimal Resource Allocation Using Stream Directive

(71) Applicant: Western Digital Technologies, Inc., San Jose, CA (US)

(72) Inventors: Kartheshwar Shanmugasundaram, Tamil Nadu (IN); Saifullah Mohiddin Nalatwad, Bangalore (IN)

(73) Assignee: Western Digital Technologies, Inc., San Jose, CA (US)

(21) Appl. No.: 16/196,429

(22) Filed: Nov. 20, 2018

(51) Int. Cl. G06F 3/06

(52) U.S. Cl. CPC G06F 3/0655; G06F 3/0679; G06F 3/0604

(57) ABSTRACT

A storage system and method for optimal resource allocation using stream directive are provided. In one embodiment, a storage system is presented comprising a memory and a controller. The controller is configured to track write frequency in the memory of each of a plurality of streams received from a host; assign a weight to each of the plurality of streams based on the tracked write frequency; receive a new stream from the host; and in response to the new stream and the plurality of streams exceeding a threshold number of streams, select one of the plurality of streams to deallocate based on the assigned weights of each of the plurality of streams.

### BACKGROUND

In some environments, a host can inform a storage system of the kind of write pattern it is sending to the storage system. This enables the storage system to physically store all the associated data together as the storage system knows which kind of pattern it received. For example, a host can identify a stream, which represents a group of data that belongs to identifiable sets of physical location in the memory of the storage system and, hence, can be allocated and freed together. Each stream contains a specific pattern, so the stream enables data to be written and erased efficiently, which in turn reduces garbage collection and leads to reduced write amplification, as well as efficient memory utilization.

### BRIEF DESCRIPTION OF THE DRAWINGS

FIG. 1A is a block diagram of a non-volatile storage system of an embodiment.

FIG. 1B is a block diagram illustrating a storage module of an embodiment.

FIG. 1C is a block diagram illustrating a hierarchical storage system of an embodiment.

FIG. 2A is a block diagram illustrating components of the controller of the non-volatile storage system illustrated in FIG. 1A according to an embodiment.

FIG. 2B is a block diagram illustrating components of the non-volatile memory storage system illustrated in FIG. 1A according to an embodiment.

FIG. 3 is a graph of an embodiment illustrating performance when the number of streams is greater than the maximum stream limit.

FIG. 4 is a flowchart of a method of an embodiment for clearing an arbitrary stream resource.

FIGS. 5A-5E are illustrations of a method of an embodiment for clearing an arbitrary stream resource.

FIGS. 6A-6E are illustrations of a method of an embodiment for clearing a stream resource using weighing.

FIG. 7 is flowchart of a method of an embodiment for clearing a stream resource using weighing.

FIG. 8 is a graph of an embodiment illustrating performance when the number of streams is greater than the maximum stream limit.

### DETAILED DESCRIPTION

By way of introduction, the below embodiments relate to a storage system and method for optimal resource allocation using stream directive.

In one embodiment, a storage system is presented comprising a memory and a controller. The controller is configured to track write frequency in the memory of each of a plurality of streams received from a host; assign a weight to each of the plurality of streams based on the tracked write frequency; receive a new stream from the host; and in response to the new stream and the plurality of streams exceeding a threshold number of streams, select one of the plurality of streams to deallocate based on the assigned weights of each of the plurality of streams.

In some embodiments, the controller is further configured to receive information from the host indicating that a set of data belongs to a particular stream.

In some embodiments, the information comprises a directive.

In some embodiments, each of the plurality of streams is identified by a respective stream identifier.

In some embodiments, the controller is configured to select one of the plurality of streams to deallocate based on a greedy algorithm.

In some embodiments, the greedy algorithm comprises a least-recently-used algorithm.

In some embodiments, the least-recently-used algorithm uses a doubly-linked-list data structure with front and rear pointers.

In some embodiments, the memory comprises a three-dimensional memory.

In some embodiments, the storage system is removably connectable to the host.

In some embodiments, the storage system is embedded in the host.

In another embodiment, a method for resource allocation for streams in a storage system is presented. The method comprise receiving a stream of data from a host to store in a memory; determining whether a number of streams already allocated in the storage system meets a predetermined number; and in response to determining that the number of streams already allocated in the storage system meets the predetermined number, deallocating a least-recently-used stream of the streams already allocated in the storage system.

In some embodiments, the method further comprises receiving a directive command from the host identifying the stream of data.

In some embodiments, the least-recently-used stream is located at a rear of a doubly-linked list.

In some embodiments, the method further comprises in response to determining that the number of streams allocated in the storage system is below the predetermined number, moving the steam to a front of a doubly-linked list.

In some embodiments, the memory comprises a three-dimensional memory.

In another embodiment, a storage system is presented comprising a memory; means for tracking use frequency of each of a plurality of streams writing to the memory; and means for deallocating one of the plurality of streams based on a least-frequently- used algorithm.

In some embodiments, the storage system further comprises means for receiving a directive command from a host identifying a stream.

In some embodiments, the least-recently-used algorithm uses a doubly-linked-list data structure with front and rear pointers.

In some embodiments, the storage system further comprises means for determining whether a number of streams already allocated in the storage system meets a predetermined number.

In some embodiments, the memory comprises a three-dimensional memory.

Other embodiments are possible, and each of the embodiments can be used alone or together in combination. Accordingly, various embodiments will now be described with reference to the attached drawings.

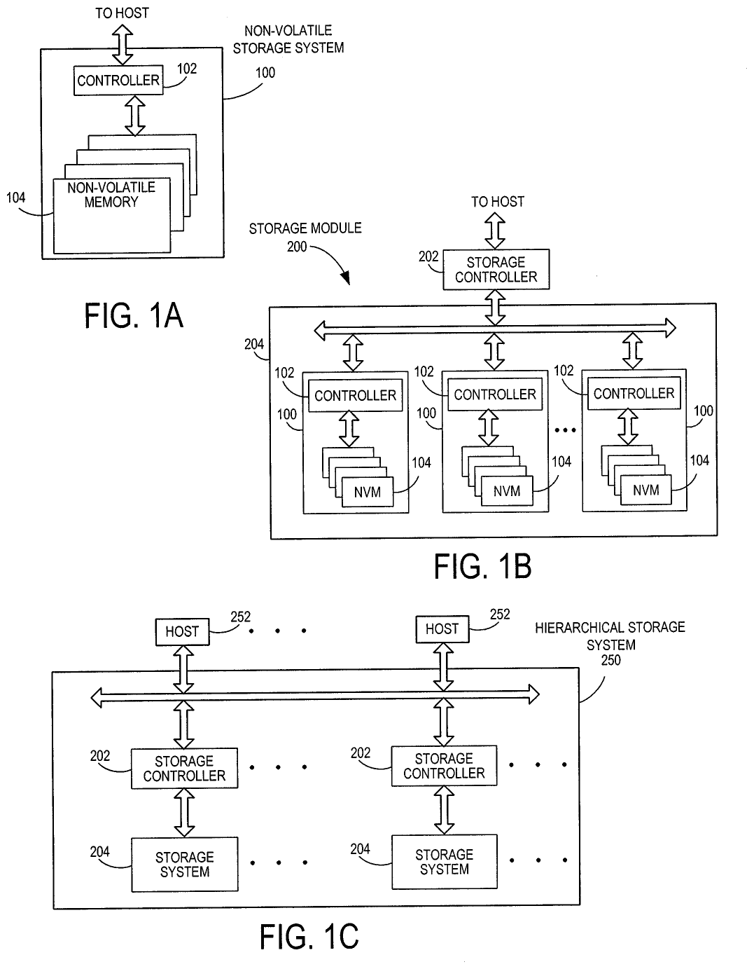

Turning now to the drawing, storage systems suitable for use in implementing aspects of these embodiments are shown in FIGS. 1A-1C. FIG. 1A is a block diagram illustrating a non-volatile storage system 100 according to an embodiment of the subject matter described herein. Referring to FIG. 1A, non-volatile storage system 100 includes a controller 102 and non-volatile memory that may be made up of one or more non-volatile memory die 104. As used herein, the term die refers to the collection of non- volatile memory cells, and associated circuitry for managing the physical operation of those non-volatile memory cells, that are formed on a single semiconductor substrate. (The terms “memory” and “media” may be used interchangeably herein.) Controller 102 interfaces with a host system and transmits command sequences for read, program, and erase operations to non-volatile memory die 104.

The controller 102 (which may be a flash memory controller) can take the form of processing circuitry, a microprocessor or processor, and a computer-readable medium that stores computer-readable program code (e.g., firmware) executable by the (micro)processor, logic gates, switches, an application specific integrated circuit (ASIC), a programmable logic controller, and an embedded microcontroller, for example. The controller 102 can be configured with hardware and/or firmware to perform the various functions described below and shown in the flow diagrams. Also, some of the components shown as being internal to the controller can also be stored external to the controller, and other components can be used. Additionally, the phrase “operatively in communication with” could mean directly in communication with or indirectly (wired or wireless) in communication with through one or more components, which may or may not be shown or described herein.

As used herein, a flash memory controller is a device that manages data stored on flash memory and communicates with a host, such as a computer or electronic device. A flash memory controller can have various functionality in addition to the specific functionality described herein. For example, the flash memory controller can format the flash memory to ensure the memory is operating properly, map out bad flash memory cells, and allocate spare cells to be substituted for future failed cells. Some part of the spare cells can be used to hold firmware to operate the flash memory controller and implement other features. In operation, when a host needs to read data from or write data to the flash memory, it will communicate with the flash memory controller. If the host provides a logical address to which data is to be read/written, the flash memory controller can convert the logical address received from the host to a physical address in the flash memory. (Alternatively, the host can provide the physical address.) The flash memory controller can also perform various memory management functions, such as, but not limited to, wear leveling (distributing writes to avoid wearing out specific blocks of memory that would otherwise be repeatedly written to) and garbage collection (after a block is full, moving only the valid pages of data to a new block, so the full block can be erased and reused).

Non-volatile memory die 104 may include any suitable non-volatile storage medium, including NAND flash memory cells and/or NOR flash memory cells. The memory cells can take the form of solid-state (e.g., flash) memory cells and can be one- time programmable, few-time programmable, or many-time programmable. The memory cells can also be single-level cells (SLC), multiple-level cells (MLC), triple-level cells (TLC), or use other memory cell level technologies, now known or later developed. Also, the memory cells can be fabricated in a two-dimensional or three-dimensional fashion.

The interface between controller 102 and non-volatile memory die 104 may be any suitable flash interface, such as Toggle Mode 200, 400, or 800. In one embodiment, storage system 100 may be a card based system, such as a secure digital (SD) or a micro secure digital (micro-SD) card. In an alternate embodiment, storage system 100 may be part of an embedded storage system.

Although, in the example illustrated in FIG. 1A, non-volatile storage system 100 (sometimes referred to herein as a storage module) includes a single channel between controller 102 and non-volatile memory die 104, the subject matter described herein is not limited to having a single memory channel. For example, in some NAND storage system architectures (such as the ones shown in FIGS. 1B and 1C), 2, 4, 8 or more NAND channels may exist between the controller and the NAND memory device, depending on controller capabilities. In any of the embodiments described herein, more than a single channel may exist between the controller and the memory die, even if a single channel is shown in the drawings.

FIG. 1B illustrates a storage module 200 that includes plural non-volatile storage systems 100. As such, storage module 200 may include a storage controller 202 that interfaces with a host and with storage system 204, which includes a plurality of non-volatile storage systems 100. The interface between storage controller 202 and non-volatile storage systems 100 may be a bus interface, such as a serial advanced technology attachment (SATA) or peripheral component interface express (PCIe) interface. Storage module 200, in one embodiment, may be a solid state drive (SSD), such as found in portable computing devices, such as laptop computers, and tablet computers.

FIG. 1C is a block diagram illustrating a hierarchical storage system. A hierarchical storage system 250 includes a plurality of storage controllers 202, each of which controls a respective storage system 204. Host systems 252 may access memories within the storage system via a bus interface. In one embodiment, the bus interface may be an NVMe or fiber channel over Ethernet (FCoE) interface. In one embodiment, the system illustrated in FIG. 1C may be a rack mountable mass storage system that is accessible by multiple host computers, such as would be found in a data center or other location where mass storage is needed.

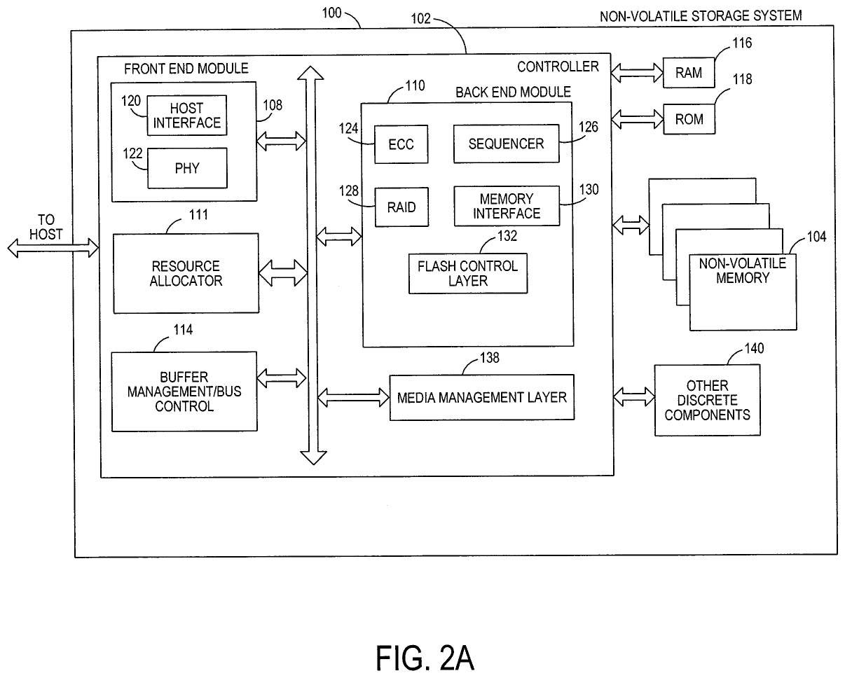

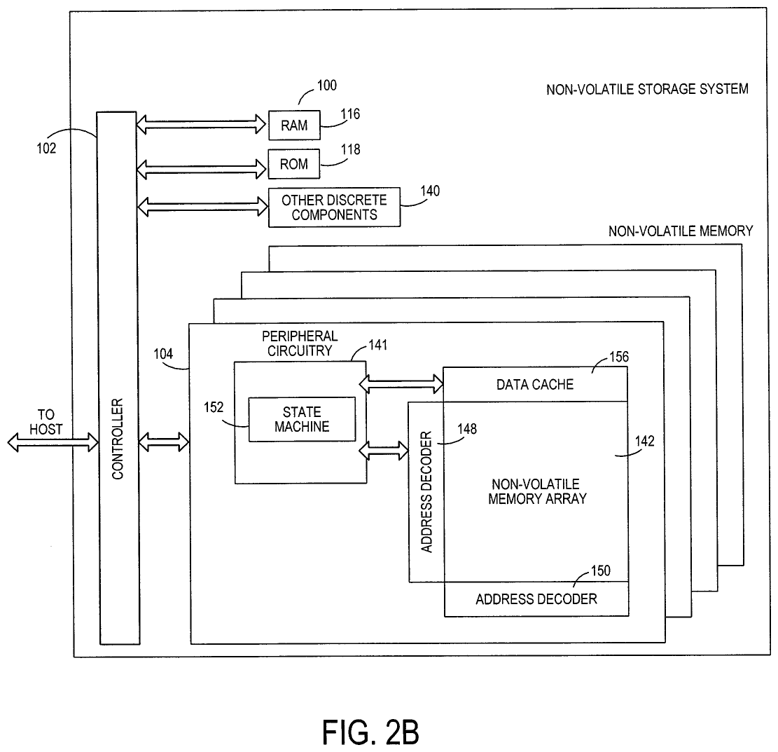

FIG. 2A is a block diagram illustrating components of controller 102 in more detail. Controller 102 includes a front end module 108 that interfaces with a host, a back end module 110 that interfaces with the one or more non-volatile memory die 104, and various other modules that perform functions which will now be described in detail. For example, in this embodiment, the controller 102 comprises a resource allocator 111, which will be discussed in more detail below. A module may take the form of a packaged functional hardware unit designed for use with other components, a portion of a program code (e.g., software or firmware) executable by a (micro)processor or processing circuitry that usually performs a particular function of related functions, or a self-contained hardware or software component that interfaces with a larger system, for example.

Referring again to modules of the controller 102, a buffer manager/bus controller 114 manages buffers in random access memory (RAM) 116 and controls the internal bus arbitration of controller 102. A read only memory (ROM) 118 stores system boot code. Although illustrated in FIG. 2A as located separately from the controller 102, in other embodiments one or both of the RAM 116 and ROM 118 may be located within the controller. In yet other embodiments, portions of RAM and ROM may be located both within the controller 102 and outside the controller.

Front end module 108 includes a host interface 120 and a physical layer interface (PHY) 122 that provide the electrical interface with the host or next level storage controller. The choice of the type of host interface 120 can depend on the type of memory being used. Examples of host interfaces 120 include, but are not limited to, SATA, SATA Express, SAS, Fibre Channel, USB, PCIe, and NVMe. The host interface 120 typically facilitates transfer for data, control signals, and timing signals.

Back end module 110 includes an error correction controller (ECC) engine 124 that encodes the data bytes received from the host, and decodes and error corrects the data bytes read from the non-volatile memory. A command sequencer 126 generates command sequences, such as program and erase command sequences, to be transmitted to non-volatile memory die 104. A RAID (Redundant Array of Independent Drives) module 128 manages generation of RAID parity and recovery of failed data. The RAID parity may be used as an additional level of integrity protection for the data being written into the memory device 104. In some cases, the RAID module 128 may be a part of the ECC engine 124. A memory interface 130 provides the command sequences to non-volatile memory die 104 and receives status information from non-volatile memory die 104. In one embodiment, memory interface 130 may be a double data rate (DDR) interface, such as a Toggle Mode 200, 400, or 800 interface. A flash control layer 132 controls the overall operation of back end module 110.

The storage system 100 also includes other discrete components 140, such as external electrical interfaces, external RAM, resistors, capacitors, or other components that may interface with controller 102. In alternative embodiments, one or more of the physical layer interface 122, RAID module 128, media management layer 138 and buffer management/bus controller 114 are optional components that are not necessary in the controller 102.

FIG. 2B is a block diagram illustrating components of non-volatile memory die 104 in more detail. Non-volatile memory die 104 includes peripheral circuitry 141 and non-volatile memory array 142. Non-volatile memory array 142 includes the non-volatile memory cells used to store data. The non-volatile memory cells may be any suitable non-volatile memory cells, including NAND flash memory cells and/or NOR flash memory cells in a two dimensional and/or three dimensional configuration. Non-volatile memory die 104 further includes a data cache 156 that caches data.

The storage system 100 can be used with a host, both of which can operated under a standard or specification. One such specification is the Non-Volatile Memory Express (NVMe) specification. In the NVMe 1.3 specification released at May 1, 2017, a new feature called directive has been introduced. Directive is a mechanism to enable the host to exchange information with controller. One of the implications of this feature allows the host to inform the storage system (sometimes referred to herein as the storage media or device) which kind of storage pattern it is sending to device. This enables the storage media to physically store all the associated data together as the storage media knows which kind of pattern it received. Directives are implemented with the help of streams. A stream represents a group of data that belong to identifiable sets of physical location and, hence, can be allocated and freed together. Each stream contains a specific pattern. So, streams enable data to be written and erased efficiently, which in turn reduces garbage collection and leads to reduced write amplification, as well as efficient flash utilization.

For exercising the directive command of the NVMe specification, there are certain resources that may need to be utilized; namely, stream resources. Stream resources are the resources in the NVM subsystem that track operations associated with a specified stream identifier. But there can be a maximum threshold of the number of stream resources that are available in an NVM subsystem characterized by a Max Streams limit (MSL). The NVMe Subsystem streams available (NSSA) indicates the number of subsystem stream resources available.

For a namespace that has a non-zero value of NVMe Subsystem streams available, if the host submits a write command specifying a new stream identifier not currently in use and all stream resources are exhausted, then an arbitrary stream identifier from the existing streams for that namespace is released by the controller to free the stream resources associated with that stream identifier for the newly-added stream. While the streams are deallocated, the host buffers the incoming data into its DRAM, and, when the resources are allocated, the data from the host is flushed into the storage media through the new allocated stream. As a result of arbitrary deallocation of streams, a latency is introduced, which causes a drop in performance. Therefore, dips are observed in the performance graphs. Also, if such operation happens successively, the load on the host to buffer the data increases, and, if the buffer is not sufficient enough, it can lead to loss of data. In a host, such as a camera, it may be preferred that such dip scenarios occur as minimally as possible.

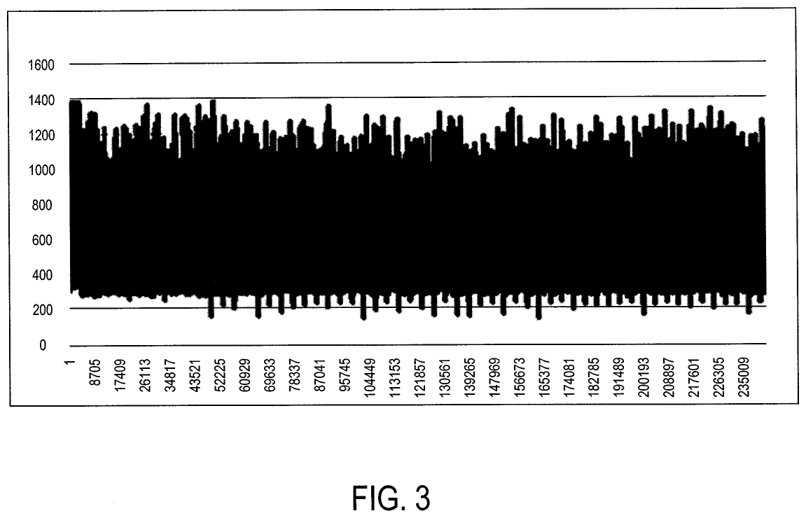

Consider a system that contains patterns for which some streams occur at a higher frequency compared to other streams. An efficient system would try to keep the number of deallocation of resources as minimal as possible. In some storage systems, any random stream's resources are cleared. So, there is a possibility that the stream resources for the frequently-occurring stream can be released. Since the frequently-occurring stream resource has been deallocated, in subsequent iterations, it is very likely that the host will request a stream that has been deallocated recently (the most occurring pattern). This leads to the repeated process of allocation and deallocation of stream resources. Therefore, the dips in performance would be more frequent. FIG. 3 shows the illustrative performance graph when there are more streams than the maximum stream limit (MSL).

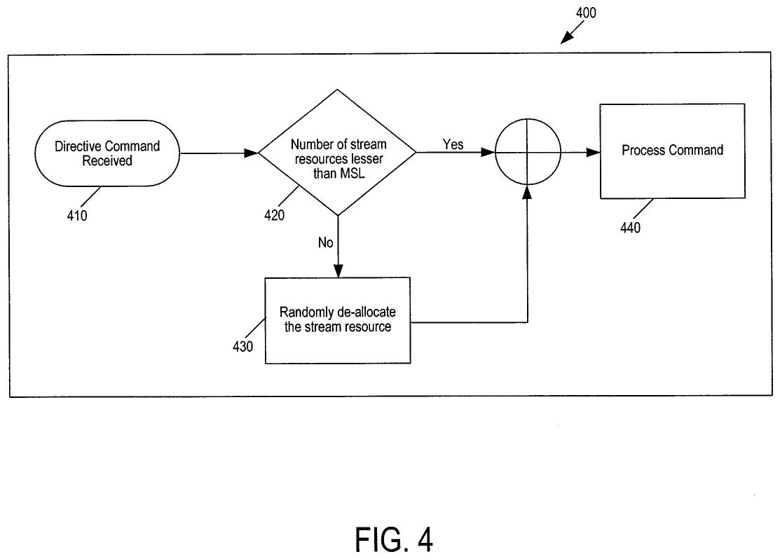

In some systems, if the number of NVMe subsystem stream resources available is non zero, then the device accepts the directive command and allocates resources for the stream ID sent by the host. If a command with a stream already in use is sent from the host, the command is processed without any intervention. However, if a directive command is sent by the host for which stream resources are not allocated and the number of stream resources available is also zero, then an arbitrary stream resource is cleared. This is depicted in the flowchart 400 of FIG. 4.

As shown in FIG. 4, in this method, first, a directive command from the host is received by the storage system 100 (act 410). Then, the controller 102 (e.g., the resource allocator 111) determines if the number of stream resources is less than the MSL (act 420). If it is, the storage system 100 processes the command (act 440). If it is not, the storage system 100 randomly deallocates a stream resource (act 430) and then processes the command (act 440).

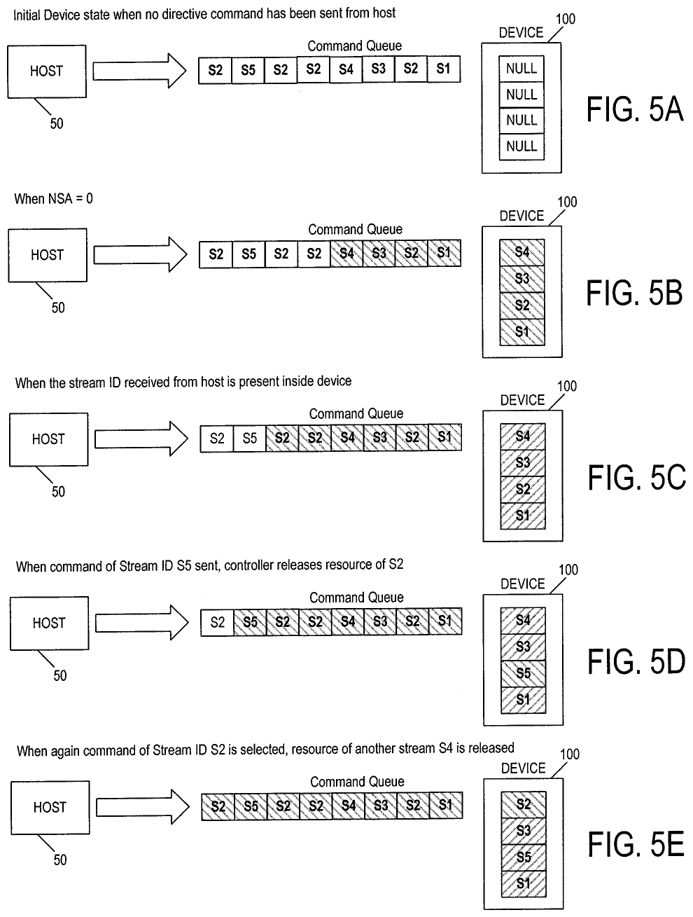

FIGS. 5A-5E are illustrations of a method of an embodiment for clearing an arbitrary stream resource. FIG. 5A shows the initial device state when no directive command has been sent from the host. FIG. 5B is when NSA=0. FIG. 5C is when the stream ID received from the host is present inside the device. FIG. 5D is when the command of stream ID S5 is sent, and the controller 102 releases the resource of S2. FIG. 5E is when the command of stream ID S2 is again selected, and a resource of another stream (here, S4) is released.

As noted above, such arbitrary deallocation of streams can introduce a latency that can cause a drop in performance. Accordingly, this method does not cater to a system that has varying frequency of occurrences of streams. The following embodiments provide an optimal mechanism that can ensure that stream resources are released in a prescribed algorithm which presents a more-favorable utilization of the stream resources.

In one embodiment, in order to manage which resources have to be released when a stream for which resources are not allocated and NSSA is zero, a greedy algorithm is used. As used herein, a greedy algorithm refers to an algorithmic paradigm that follows the problem solving heuristic of making the locally optimal choice at each stage with the method of finding a global optimum. Greedy algorithms try to find a localized optimum solution, which will eventually lead to globally optimized solutions.

This embodiment recognizes that the main problem of the method of FIG. 4 is that it fails to assign priority to streams because it considers every stream in the pool of streams of equal priority. However, if the system assigns unique weight (priority) to every stream the host initiates, the selection of the resource to be deallocated can be optimized.

In one embodiment, the storage system 100 keeps track of every directive command's stream ID sent from the host. The stream that has a higher frequency (write activity) is given extra weight when compared to a stream of lower occurrence. So, different weights are assigned to each stream that is currently active in the system. The most-frequently active pattern sent by the host is characterized by the stream that has the highest weight associated with it, and vice versa. When all the resources available are allocated, the storage system 100 can release the stream corresponding to the least weight. This makes sure that the resources of the least-occurring pattern are cleared, thereby making sure that the system takes minimal time for allocation and deallocation of resources.

In one embodiment, the greedy scheme is implemented pragmatically with the help of a least-recently-used algorithm (LRU). The least-recently-used algorithm can be implemented with the help of a doubly linked list data structure. In that implementation, there can be two pointers of the doubly linked list, namely FRONT and REAR. The number of active nodes in the doubly linked list can be given by the difference of the FRONT and REAR pointers and is tantamount to the NVMe subsystem stream available (NSSA) metric. The maximum size of the doubly linked list can be the maximum stream length (MSL).

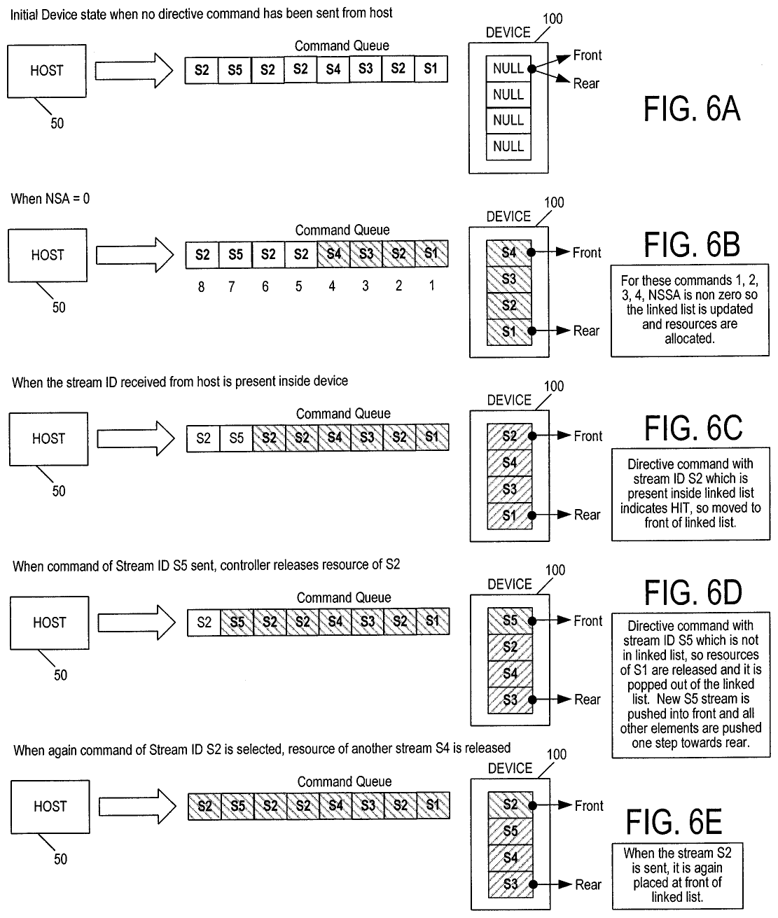

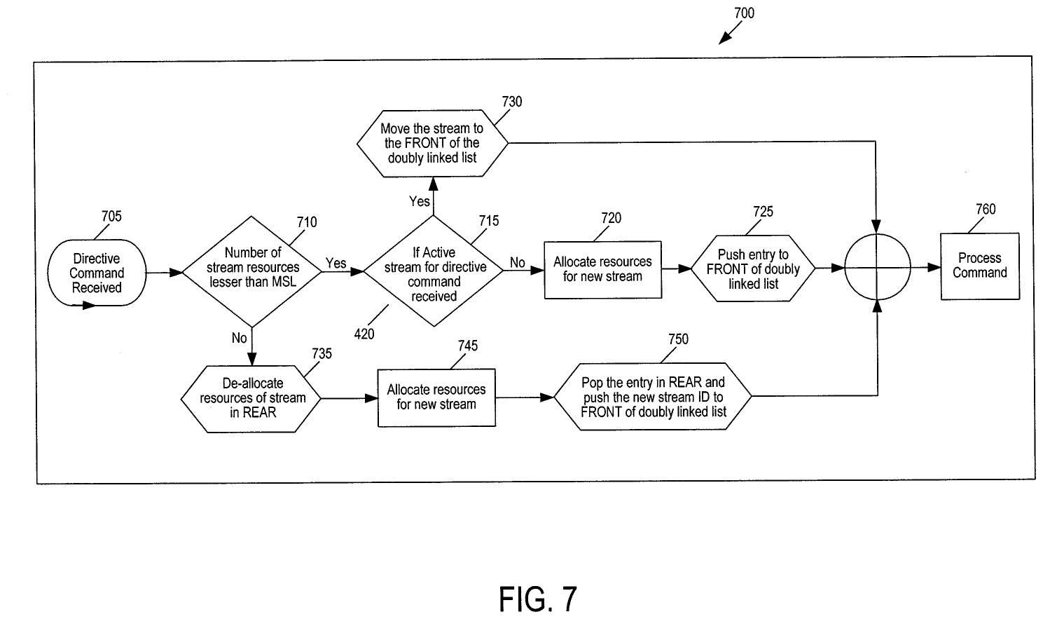

In operation, whenever a host sends a command with directive enabled, the doubly linked list has its nodes updated to the stream ID through the FRONT pointer. If the number of active nodes inside the doubly linked list is less than MSL (NSSA is non zero), the stream has the resources allocated, and the stream ID is pushed to the linked list through the FRONT pointer. If a command pertains to a stream that already has its resources allocated, the stream ID present in the doubly linked list is moved to the FRONT pointer, and the doubly linked list is updated. If a command with a stream ID is not in any of the nodes of doubly linked list and NSSA is zero, the resources of the stream in the REAR of the doubly linked list are released, the node in the REAR is popped from linked list, and the new stream is updated through the FRONT. In this way, resources are allocated to the new stream. This embodiment will now be discussed in conjunction with FIGS. 6A-6E and FIG. 7.

FIG. 7 is flowchart 700 of a method of an embodiment for clearing a stream resource using weighing As shown in FIG. 7, in this embodiment, the storage system 100 receives a directive command from the host (act 705). Then, the controller 102 of the storage system 100 determines if the number of stream resources is less than MSL (act 710). If it is, the storage system 100 determines if the active stream for the directive command is received (act 715). If it is, the storage system 100 moves the stream to the front of the doubly linked list (act 730) and processes the command (act 760). If the active stream for the directive command is not received, the storage system 100 allocates resources to the new stream (act 720), pushes the entry to the front of the doubly linked list (act 725), and processes the command (act 760).

If the number of stream resources is not less than MSL, the storage system 100 deallocates resources of the stream in the rear (act 735), allocates resources for the new stream (act 745), pops the entry in the rear, pushes the new stream ID to the front of the doubly linked list (act 750), and processes the command (act 760).

FIGS. 6A-6E illustrated this. FIG. 6A shows the initial device state when no directive command has been sent from the host. FIG. 6B shows when NSA=0. FIG. 6C shows when the stream ID received from the host is present inside the device. FIG. 6D shows that when the command of stream ID S5 is sent, the controller 102 releases the resource of S2. FIG. 6E shows that when the command of stream ID S2 is again selected, the resource of stream S4 is released.

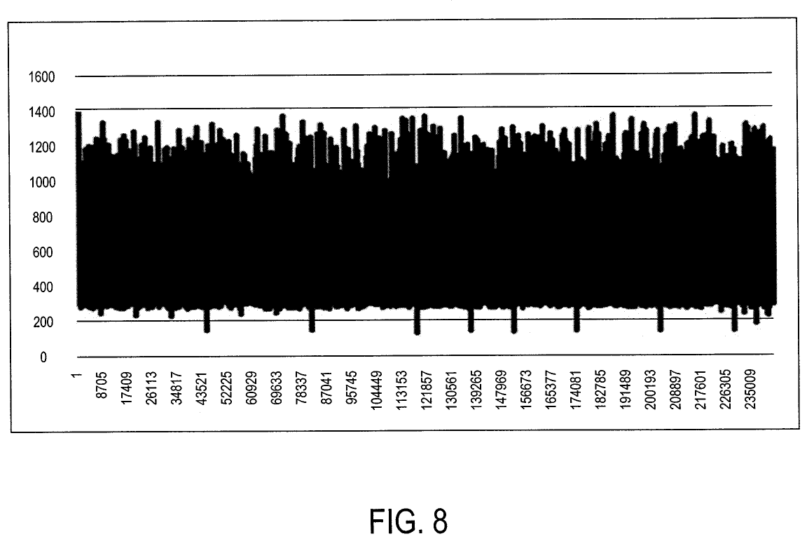

This method can help ensure optimal resource allocation-deallocation when all the stream resources are exhausted. So, the number of dips in the performance graphs is reduced significantly (see FIG. 8). The number of times the host needs to buffer its data because of unavailability of streams is also reduced, as the number of times the resources are deallocated and allocated is reduced. There are several other advantages associated with these embodiments. For example, write performance is enhanced as the number of dips in the systems are reduced, and the streams which are frequently occurring always have the resources allocated. So, the controller 102 need not waste its time in deallocating the resources. Additionally, these embodiments can reduce the controller operations as the de-allocation of resources happens at a lesser rate. Further, reducing the number of dips in write performance can be important for devices that are compliant with a video performance guarantee where performance is crucial. Additionally, the load on the host can be reduced with these embodiments.

Finally, as mentioned above, any suitable type of memory can be used. Semiconductor memory devices include volatile memory devices, such as dynamic random access memory (“DRAM”) or static random access memory (“SRAM”) devices, non-volatile memory devices, such as resistive random access memory (“ReRAM”), electrically erasable programmable read only memory (“EEPROM”), flash memory (which can also be considered a subset of EEPROM), ferroelectric random access memory (“FRAM”), and magnetoresistive random access memory (“MRAM”), and other semiconductor elements capable of storing information. Each type of memory device may have different configurations. For example, flash memory devices may be configured in a NAND or a NOR configuration.

The memory devices can be formed from passive and/or active elements, in any combinations. By way of non-limiting example, passive semiconductor memory elements include ReRAM device elements, which in some embodiments include a resistivity switching storage element, such as an anti-fuse, phase change material, etc., and optionally a steering element, such as a diode, etc. Further by way of non-limiting example, active semiconductor memory elements include EEPROM and flash memory device elements, which in some embodiments include elements containing a charge storage region, such as a floating gate, conductive nanoparticles, or a charge storage dielectric material.

Multiple memory elements may be configured so that they are connected in series or so that each element is individually accessible. By way of non-limiting example, flash memory devices in a NAND configuration (NAND memory) typically contain memory elements connected in series. A NAND memory array may be configured so that the array is composed of multiple strings of memory in which a string is composed of multiple memory elements sharing a single bit line and accessed as a group. Alternatively, memory elements may be configured so that each element is individually accessible, e.g., a NOR memory array. NAND and NOR memory configurations are examples, and memory elements may be otherwise configured.

The semiconductor memory elements located within and/or over a substrate may be arranged in two or three dimensions, such as a two dimensional memory structure or a three dimensional memory structure.

In a two dimensional memory structure, the semiconductor memory elements are arranged in a single plane or a single memory device level. Typically, in a two dimensional memory structure, memory elements are arranged in a plane (e.g., in an x-z direction plane) which extends substantially parallel to a major surface of a substrate that supports the memory elements. The substrate may be a wafer over or in which the layer of the memory elements are formed or it may be a carrier substrate which is attached to the memory elements after they are formed. As a non-limiting example, the substrate may include a semiconductor such as silicon.

The memory elements may be arranged in the single memory device level in an ordered array, such as in a plurality of rows and/or columns. However, the memory elements may be arrayed in non-regular or non-orthogonal configurations. The memory elements may each have two or more electrodes or contact lines, such as bit lines and wordlines.

A three dimensional memory array is arranged so that memory elements occupy multiple planes or multiple memory device levels, thereby forming a structure in three dimensions (i.e., in the x, y and z directions, where the y direction is substantially perpendicular and the x and z directions are substantially parallel to the major surface of the substrate).

As a non-limiting example, a three dimensional memory structure may be vertically arranged as a stack of multiple two dimensional memory device levels. As another non-limiting example, a three dimensional memory array may be arranged as multiple vertical columns (e.g., columns extending substantially perpendicular to the major surface of the substrate, i.e., in the y direction) with each column having multiple memory elements in each column. The columns may be arranged in a two dimensional configuration, e.g., in an x-z plane, resulting in a three dimensional arrangement of memory elements with elements on multiple vertically stacked memory planes. Other configurations of memory elements in three dimensions can also constitute a three dimensional memory array.

By way of non-limiting example, in a three dimensional NAND memory array, the memory elements may be coupled together to form a NAND string within a single horizontal (e.g., x-z) memory device levels. Alternatively, the memory elements may be coupled together to form a vertical NAND string that traverses across multiple horizontal memory device levels. Other three dimensional configurations can be envisioned wherein some NAND strings contain memory elements in a single memory level while other strings contain memory elements which span through multiple memory levels. Three dimensional memory arrays may also be designed in a NOR configuration and in a ReRAM configuration.

Typically, in a monolithic three dimensional memory array, one or more memory device levels are formed above a single substrate. Optionally, the monolithic three dimensional memory array may also have one or more memory layers at least partially within the single substrate. As a non-limiting example, the substrate may include a semiconductor such as silicon. In a monolithic three dimensional array, the layers constituting each memory device level of the array are typically formed on the layers of the underlying memory device levels of the array. However, layers of adjacent memory device levels of a monolithic three dimensional memory array may be shared or have intervening layers between memory device levels.

Then again, two dimensional arrays may be formed separately and then packaged together to form a non-monolithic memory device having multiple layers of memory. For example, non-monolithic stacked memories can be constructed by forming memory levels on separate substrates and then stacking the memory levels atop each other. The substrates may be thinned or removed from the memory device levels before stacking, but as the memory device levels are initially formed over separate substrates, the resulting memory arrays are not monolithic three dimensional memory arrays. Further, multiple two dimensional memory arrays or three dimensional memory arrays (monolithic or non-monolithic) may be formed on separate chips and then packaged together to form a stacked-chip memory device.

Associated circuitry is typically required for operation of the memory elements and for communication with the memory elements. As non-limiting examples, memory devices may have circuitry used for controlling and driving memory elements to accomplish functions such as programming and reading. This associated circuitry may be on the same substrate as the memory elements and/or on a separate substrate. For example, a controller for memory read-write operations may be located on a separate controller chip and/or on the same substrate as the memory elements.

One of skill in the art will recognize that this invention is not limited to the two dimensional and three dimensional structures described but cover all relevant memory structures within the spirit and scope of the invention as described herein and as understood by one of skill in the art.

It is intended that the foregoing detailed description be understood as an illustration of selected forms that the invention can take and not as a definition of the invention. It is only the following claims, including all equivalents, that are intended to define the scope of the claimed invention. Finally, it should be noted that any aspect of any of the embodiments described herein can be used alone or in combination with one another.

What is claimed is:

1. A storage system comprising:
a memory; and
a controller configured to:
track, for each stream of a plurality of streams received from a host, write frequency in the memory;
assign, based on the tracked write frequency, a weight to each stream of the plurality of streams;
receive, from the host, a new stream; and
in response to the new stream and the plurality of streams exceeding a threshold number of streams, select one stream of the plurality of streams to deallocate based on the assigned weights of each stream of the plurality of streams.

2. The storage system of claim 1, wherein the controller is further configured to receive, from the host, information indicating that a set of data belongs to a particular stream.

3. The storage system of claim 2, wherein the information comprises a directive.

4. The storage system of claim 1, wherein each stream of the plurality of streams is identified by a respective stream identifier.

5. The storage system of claim 1, wherein the controller is further configured to select, based on a greedy algorithm, one stream of the plurality of streams to deallocate.

6. The storage system of claim 5, wherein the greedy algorithm comprises a least-recently-used algorithm.

7. The storage system of claim 6, wherein the least-recently-used algorithm uses a doubly-linked-list data structure with front and rear pointers.

8. The storage system of claim 1, wherein the memory comprises a three-dimensional memory.

9. The storage system of claim 1, wherein the storage system is removably connectable to the host.

10. The storage system of claim 1, wherein the storage system is embedded in the host.

11. A method for resource allocation for streams in a storage system, the method comprising:
performing the following in a storage system comprising a memory:
receiving, from a host, a stream of data to store in the memory;
determining whether a number of streams already allocated in the storage system meets a predetermined number; and
in response to determining that the number of streams already allocated in the storage system meets the predetermined number, deallocating a least-recently-used stream of the streams already allocated in the storage system.

12. The method of claim 11, further comprising receiving, from the host, a directive command identifying the stream of data.

13. The method of claim 11, wherein the least-recently-used stream is located at a rear of a doubly-linked list.

14. The method of claim 11, further comprising in response to determining that the number of streams allocated in the storage system is below the predetermined number, moving the stream to a front of a doubly-linked list.

15. The method of claim 11, wherein the memory comprises a three-dimensional memory.

16. A storage system comprising:
a memory;
means for tracking use frequency of each stream of a plurality of streams writing to the memory; and
means for deallocating one stream of the plurality of streams based on a least-frequently-used algorithm.

17. The storage system of claim 16, further comprising means for receiving, from a host, a directive command identifying a stream.

18. The storage system of claim 16, wherein the least-recently-used algorithm uses a doubly-linked-list data structure with front and rear pointers.

19. The storage system of claim 16, further comprising means for determining whether a number of streams already allocated in the storage system meets a predetermined number.

20. The storage system of claim 16, wherein the memory comprises a three-dimensional memory.
